(19) United States
(12) Patent Application Publication
(10) Pub. No.: US 2005/0046592 A1
(43) Pub. Date: Mar. 3, 2005

(54) Priority data transmission in a wireline telemetry system

(75) Inventors: Homi P. Cooper, Houston, TX (US); Carl Dodge, Houston, TX (US); Clovis S. Bonavides, Houston, TX (US); Alberto Quintero, Katy, TX (US); Wallace R. Gardner, Houston, TX (US)

Correspondence Address: CONLEY ROSE, P.C., P. O. BOX 3267, HOUSTON, TX, 77253-3267, US

(73) Assignee: Halliburton Energy Services, Inc., Houston, TX (US)

(21) Appl. No.: 10/651,359

(22) Filed: Aug. 29, 2003

(51) Int. Cl. G08C 19/22; G01V 3/00

(52) U.S. Cl. 340/855.7

(57) ABSTRACT

A downhole telemetry system having a surface transceiver, a cable, and a downhole transceiver. The downhole transceiver transmits a first category of data over a first set of frequency subchannels and a second category of data over a second set of frequency subchannels. The frequency subchannels of the first set preferably have lower error rate than the frequency subchannels of the second set. The first category of data may include data from a tool, data from a group of sensors within a tool, data sampled from a data stream at a pre-determined frequency, or a combination thereof. In at least some embodiments, the first and second sets of frequency subchannels are at lower frequencies than a third set of frequency subchannels allocated for downlink communications.

### BACKGROUND

Modern petroleum drilling and production operations demand a great quantity of information relating to parameters and conditions downhole. Such information typically includes characteristics of the earth formations traversed by the wellbore, along with data relating to the size and configuration of the borehole itself. The collection of information relating to conditions downhole, which commonly is referred to as “logging”, can be performed by several methods.

In conventional oil well wireline logging, a probe or “sonde” housing formation sensors is lowered into the borehole after some or all of the well has been drilled, and is used to determine certain characteristics of the formations traversed by the borehole. The upper end of the sonde is attached to a conductive wireline that suspends the sonde in the borehole. Power is transmitted to the sensors and instrumentation in the sonde through the conductive wireline. Similarly, the instrumentation in the sonde communicates information to the surface by electrical signals transmitted through the wireline.

Information is the key to being profitable in the oil and gas industry. The more information one has regarding location and migration patterns of hydrocarbons within a hydrocarbon reservoir, the more likely it is that that reservoir can be tapped at its optimal location and utilized to its full potential. To this end, new and more sophisticated sensor arrangements are routinely created and placed in the wireline sonde.

While modern wireline telemetry systems make it possible to transmit more data uphole than has been possible in the past, errors (data corruption) in the data being transmitted may still occur. This is especially true if the telemetry channel's capacity is reduced for any reason (factors affecting channel capacity may include wireline length, borehole temperature, conditions of the cable, and electrical noise) during the transmission process. Consequently, there is a need to improve the reliability of critical data transfer over wireline telemetry systems.

### BRIEF SUMMARY OF THE INVENTION

Accordingly, there is disclosed herein a downhole telemetry system that prioritizes tool data. In one embodiment, the downhole telemetry system comprises a surface transceiver, a cable, and a downhole transceiver coupled to the surface transceiver via the cable. The downhole transceiver transmits a first category of tool data over a first set of frequency subchannels and a second category of tool data over a second set of frequency subchannels. In at least some embodiments, the frequency subchannels of the first set have a lower error rate than the frequency subchannels of the second set.

In at least some embodiments, a downhole transmitter comprises interface logic, a digital signal processor, memory, and a line interface. The interface logic receives data from one or more tools and separates the data into the first and second categories of data. The digital signal processor then assigns the first category of data to the first set of frequency subchannels and the second category of data to the second set of frequency subchannels. In at least some embodiments, the memory provides instructions to the digital signal processor and interface logic whereby the above-described processes are carried out. The first category of tool data may comprise data from a pre-determined tool or sensor, data samples selected using a pre-determined frequency, or a combination thereof.

### BRIEF DESCRIPTION OF THE DRAWINGS

For a detailed description of the preferred embodiments of the invention, reference will now be made to the accompanying drawings in which:

FIG. 1 shows wireline sonde being run through a well;

FIG. 2 shows a cross-section of a seven-conductor wireline cable;

FIG. 3a shows an embodiment of an acoustic tool;

FIG. 3b shows a cross-sectional view of a receiver ring shown in FIG. 3a;

FIG. 4 shows a transceiver according to an embodiment of the invention;

FIG. 5 shows a discrete multi-tone (DMT) transmitter according to an embodiment of the invention;

FIG. 6 shows a discrete multi-tone receiver;

FIG. 7 shows a block diagram illustrating a standard DMT-ADSL frequency subchannel assignment; and

FIG. 8 shows a block diagram illustrating a DMT-ADSL frequency subchannel assignment according to an embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections. The terms uplink and downlink refer generally, in the context of this disclosure, to the transmission of information from subsurface equipment to surface equipment, and from surface equipment to subsurface equipment, respectively. Additionally, the terms surface and subsurface are relative terms. The fact that a particular piece of hardware is described as being on the surface does not necessarily mean it must be physically above the surface of the Earth; but rather, describes only the relative location of the surface and subsurface pieces of equipment.

### DETAILED DESCRIPTION

The subject matter disclosed herein generally relates to wireline telemetry systems that transmit data between surface tools and subsurface tools. A variety of subsurface tools are typically used to collect subsurface data. These tools may be used to determine certain characteristics of the downhole environment that are useful for gathering natural resources such as petroleum as efficiently as possible.

During logging operations, the data from the tools may be digitized and processed downhole in preparation for sending the data to the surface. In at least some embodiments of the invention, the data may be categorized by a downhole processing system. In some embodiments, downhole processing may be limited to categorizing data for the purpose of separating data into a plurality of data sets. For example, information regarding which tool the data came from, which sensor the data came from, and when the data was recorded may be used to categorize the data. Additionally, some data may be compressed during downhole digitization and processing, and may be categorized based on a classification of compressed data. Particularly, some groups (bits, bytes, etc.) of compressed data may be more critical for reconstructing the data gathered by the sensors and may therefore be classified differently than “non-critical” data. These classifications or categorizations of data may be used to prioritize data during the transmission process.

As previously described, errors (or other transmission deficiencies) that occur while data is transmitted from a downhole transmitter to the surface may cause “critical” data to be lost. This may be particularly true if the information carrying capacity of the telemetry subchannel (hereafter called channel capacity) is reduced during the transmission of data. Downhole environments are often unpredictable, and many factors, may influence the channel capacity or bandwidth of the wireline telemetry system. By assigning pre-determined data types (categories) to frequency subchannels with the lowest error rate, those data types may be reliably delivered to the surface even if channel capacity is reduced. Therefore, interference, noise, and other forms of channel degradation become less significant and in many instances may be insignificant. The selection of priority data may be pre-programmable and may be implemented using configurable software/firmware on the downhole transceiver as will later be described.

In at least some embodiments, the downhole wireline telemetry system may be designed such that the uplink bandwidth for transferring tool data to the surface provides more than enough channel capacity to reliably transfer both priority and non-priority data. In such embodiments, a reduction of channel capacity (due to noise, interference, attenuation, etc.) does not necessarily cause a loss of data, and the allocation of selected “priority” data to frequency subchannels with lowest calculated error rates may be used as a precautionary procedure for unlikely, but possible situations in which the data rate capacity is severely reduced.

As will be described herein, a first set of data, called “priority data” may be assigned to frequency subchannels having the lowest calculated error rate. A second set of data, called “non-priority data” may be assigned to frequency subchannels that are not used by the “priority data” although some embodiments may assign both priority and non-priority data to the same subchannel.

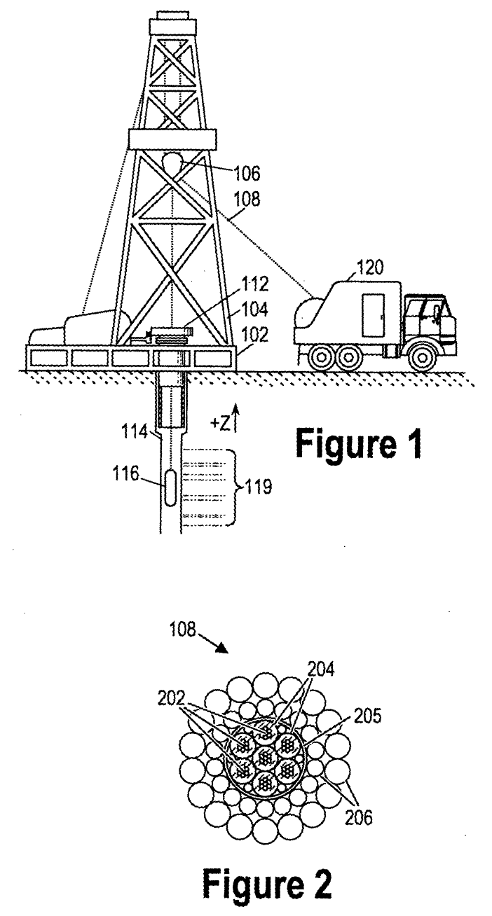

Turning now to the figures, FIG. 1 shows a well during wireline logging operations. A drilling platform 102 is equipped with a derrick 104 that supports a hoist 106. Drilling of oil and gas wells is commonly carried out by a string of drill pipes connected together by “tool” joints so as to form a drilling string that is lowered through a rotary table 112 into a wellbore 114. In FIG. 1, it is assumed that the drilling string has been temporarily removed from the wellbore 114 to allow a sonde 116 to be lowered by wireline 108 into the wellbore 114. Typically, the sonde 116 is lowered to the bottom of the region of interest and subsequently pulled upward at a constant speed. During the upward trip, the sonde 116 performs measurements on the formations 119 adjacent to the wellbore as they pass by. The measurement data is communicated to a logging facility 120 for storage, processing, and analysis. The sonde and the logging facility 120 may employ telemetry transmitters and receivers having discrete multi-tone (DMT) modulation and dynamic bandwidth allocation.

FIG. 2 shows a cross-section of a typical wireline cable (e.g., wireline 108) having multiple conductors 202. Each of the conductors 202 is surrounded by an insulating jacket 204. The insulated conductors are bundled together in a semiconductive wrap 205, which is surrounded by two layers of counterwound metal armor wire 206. Being made of metal, the armor wires are conductive and may be used as an eighth conductor.

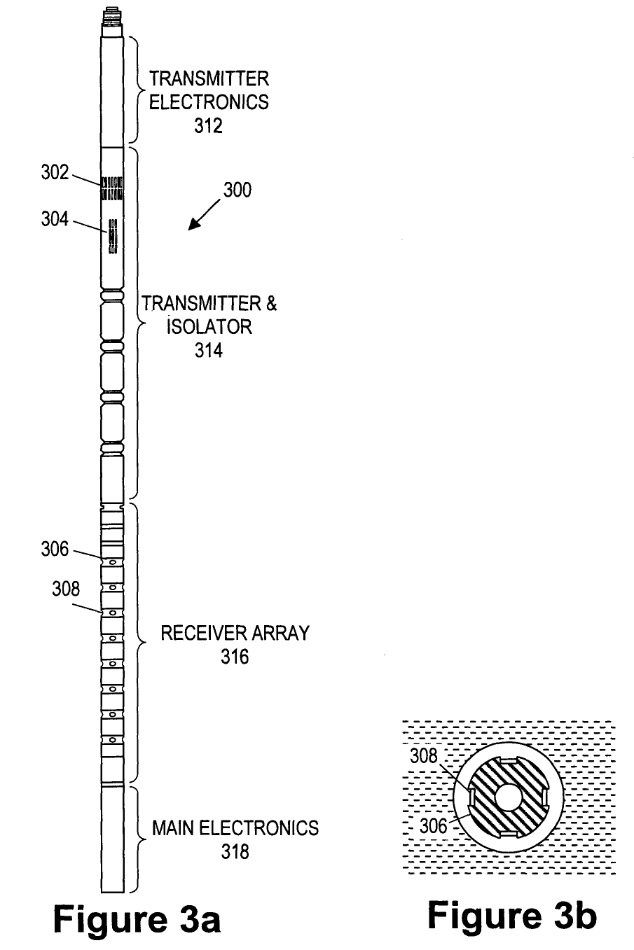

FIG. 3a shows an embodiment of an acoustic logging tool 300. For example, the sonde 116 of FIG. 1 may comprise an acoustic logging tool 300 or a number of tools (called a string of tools) including the acoustic logging tool 300. A description of how the acoustic tool functions in conjunction with possible embodiments of the invention is given below. It should be understood that while data from an acoustic logging tool 300 may be prioritized (assigned to frequency subchannels with the lowest calculated error rate) according to an exemplary embodiment of the invention, there is no particular tool data that must be prioritized. In a preferred embodiment of the invention, the prioritization of data is customizable and may be determined before logging of data begins.

As shown in FIG. 3a, the tool 300 may be divided into four sections: the main electronics section 318, the receiver array 316, the transmitter and isolator section 314, and the transmitter control electronics 312.

The main electronics section 318 controls the acquisition of the waveform data and communication with the surface. The signals from each of the 32 receiver transducers 308 are preferably digitized using high resolution (e.g. 18 bit) analog-to-digital converters (ADC) before being transmitted to the surface.

A typical transmitter firing sequence at each depth involves firing a monopole source, firing an X-X dipole, and firing a Y-Y dipole. In some embodiments, there may be a 50 ms interval between each firing (this interval is programmable), whereby the main electronics 318 may acquire 96 digitized waveforms every 500-1000 ms and send them to the surface. The process of sending the 96 digitized waveforms every 500-1000 ms requires a lot of bandwidth, as each waveform may comprise approximately 400 samples. Therefore, at least some embodiments of the invention may prioritize some acoustic data by allocating some of the 96 waveforms to frequency subchannels having the lower error rate, while the remaining waveforms are allocated to other frequency subchannels. Additionally, or alternatively, some embodiments may select certain regions of some or all waveforms as “priority data”. Because the subchannels assigned to transmit priority data provide a lower error rate, those waveforms or waveform regions considered priority data would more reliably reach the surface.

Returning to FIG. 3a, the receiver array 316 may comprise 32 receiver transducers 308 arranged in eight co-planar rings 306. As shown in the cross-sectional view of FIG. 3b, each ring 306 has four receivers 308 mounted perpendicular to the tool axis and evenly distributed at 90 degrees from each other.

The transmitter and isolator section 314 may comprise a monopole transmitter 302, a pair of crossed-dipole transmitters 304, and an acoustic isolation component. The monopole transmitter 302 may include a piezoelectric crystal of cylindrical geometry. The crystal is mounted in an arrangement that allows the transmitted acoustic energy to be essentially uniform around the circumference of the tool 300.

Each of the dipole transmitters 304 may include two transducers mounted on opposite sides of the tool 300. The crossed dipoles are mounted perpendicularly, so that together, the crossed dipoles form an on-depth quad arrangement of transducers. Each of the four dipole transducers are preferably of the “bender bar” type, i.e. a flexible surface having piezoelectric crystals on opposing sides. As the crystal on one side is driven to elongate, the crystal on the opposite side is driven to shrink. This causes the bar assembly to flex, whereby acoustic signals are transmitted by flexing the bars at the desired frequencies. The signal frequency may be programmable, however, in at least some embodiments, the transducers are preferably capable of signal frequencies between at least 0.5 kHz to 3 kHz.

The main electronics section 318 may enable the operation of the acoustic logging tool 300, and the transmitter electronics 312 may control the triggering and timing of the acoustic sources. A controller in the transmitter electronics 312 may fire the acoustic sources periodically, thereby producing acoustic pressure waves that propagate through the borehole fluid. Part of the energy from the monopole transmitter is refracted at the borehole interface and travels through the surrounding formation as a compressional wave (P-wave) and as a shear wave (S-wave). As a P-wave front (i.e., the boundary of the wave as is travels) advances, it creates P-waves (i.e., pressure waves) in the borehole fluid. Similarly, the S-wave front also may generate P-waves if its velocity through the formation is less than the velocity of propagation of sound in the borehole fluid.

The action of the dipole transmitters 304 is to flex the borehole, thereby generating a flexural wave. Low frequency flexural waves in boreholes may travel at approximately the same speed of shear waves traversing the surrounding formation. These flexural waves also generate pressure disturbances (P-waves) in the borehole fluid.

As P-waves propagate past the receiver array 316, they cause pressure variations that can be detected by the receiver array elements. The receiver array signals are preferably digitized, categorized, and assigned to frequency subchannels after which the signals may be transmitted through the telemetry system to the surface, where the signals are further processed to determine the formation characteristics.

The amount of data produced by current and future logging tools, e.g., the acoustic logging tool 300, may be sufficiently great such that a wireline telemetry system cannot efficiently transmit all the data to the surface. For example, as mentioned previously, the data rate capacity of a telemetry system may be reduced for a variety of reasons. Consequently, embodiments of the invention described below may prioritize tool data before transmission so that tool data considered priority data has a higher likelihood of arriving to the surface even if other data is lost. More specifically, embodiments of the invention may use characteristics of DMT-ADSL (Discrete Multi-Tone Asynchronous Digital Subscriber Loop) telemetry to assign selected data sets to different frequency subchannels such that “priority” data sets are assigned to more reliable subchannels, i.e., subchannels with lowest error rate. It is noted that some embodiments of the invention may “create” reliable subchannels by assigning fewer data bits than would be carried according to each subchannels' calculated data capacity.

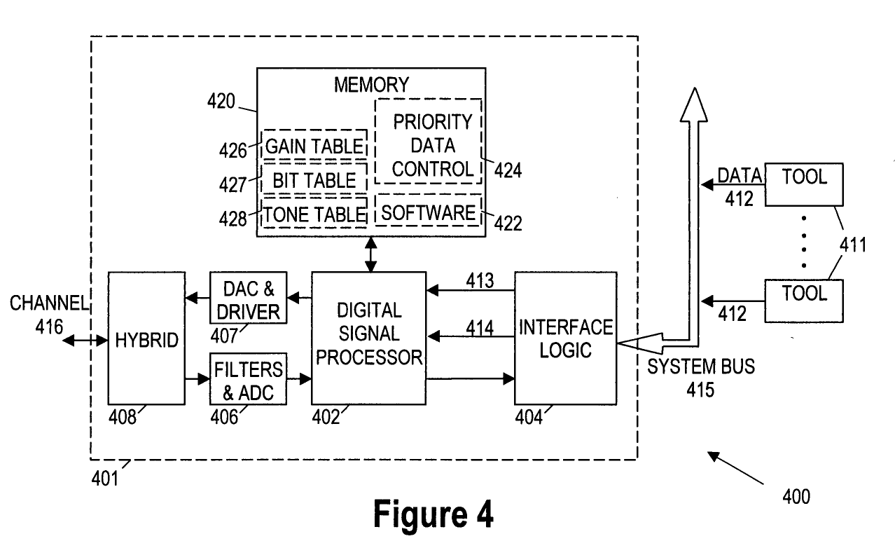

FIG. 4 shows a system 400 that prioritizes and transmits data according to a preferred embodiment of the invention. As shown in FIG. 4, the system 400 may comprise a tranceiver 401 that comprises a digital signal processor 402, interface logic 404, filters and ADC (Analog-to-Digital Converter) 406, a driver and DAC (Digital-to-Analog converter) 407, hybrid wires 408, and memory 420. The memory may comprise software 422, priority data control 424, a gain table 426, a bit table 427, and a tone table 428. In at least some embodiments, the transceiver 401 comprises a modem that transmits downhole data to the surface and also receives data from the surface, e.g., tool configuration data, initialization data, etc.

The transceiver 401 may couple to a plurality of tools 411 through a system bus 415. In operation, each tool 411 collects data 412, and sends the data 412 to the system bus 415. During this process the data 412 may be digitized by ADCs (not shown) and categorized. For example, a central processor (not shown) or the tools 411 may categorize data according to what tool 411 the data 412 came from, what sensor the data 412 came from, when the data 412 was created, or other factors. Additionally, some or all of the data 412 may be compressed before arriving to transceiver 400 through system bus 415.

The transceiver 400 receives the data 412 using interface logic 404. In some embodiments, the interface logic 404 may be used to categorize the data 412 and separate the data 412 into a priority data stream 413 and a non-priority data stream 414. In other embodiments, the interface logic 404 may receive data 412 that has already been categorized, but would still perform the step of separating the data 412 into a priority data stream 413 and a non-priority data stream 414. In some embodiments, the interface logic 404 may be programmable, whereby the data included in the priority data stream 413 and non-priority data stream 414 are changeable. In still other embodiments, the digital signal processor 402 may perform this separation function.

The digital signal processor 402 may receive the priority data stream 413 and non-priority data stream 414 from the interface logic 404 and perform several steps to prepare the data for transmission as will be described. In some embodiments, the digital signal processor (DSP) 402 may operate in accordance with software 422 stored in a memory 420. As previously described, memory 420 may include a gain table 426, a bit table 427, a tone table 428, and priority data control 424.

DMT (Discrete Multi-Tone) modulation typically comprises allocating bits of data to a set of frequency subchannels. In the ideal case, each frequency subchannel, or bin, would have the same data transmission rate as all the other frequency subchannels. However, the data rate for each subchannel varies for a myriad of reasons. For example, signal attenuation and/or noise may affect some subchannels more than other subchannels. More specifically, noise may affect certain subchannels whose frequency is at or near the frequency of the noise source, etc.

Signal attenuation may be affected by several factors. For example, the conductor resistance, self-inductance, conductor-to-conductor capacitance, and mutual inductance in the cable may cause a frequency-dependent attenuation of the signals passing therethrough. In some embodiments, telemetry signal transmission may be accomplished using certain symmetrical cable connections called eigenmodes. Eigenmodes are described in U.S. Pat. No. 6,469,636 entitled, “High-Power Well Logging Method and Apparatus,” which is herein incorporated by reference.

Eigenmode attenuation may vary smoothly as a function of frequency with increasing attenuation at higher frequencies. In additional to cable attenuation, other system components, such as transformers or suboptimal impedance matching connectors, may further aggravate attenuation at selected frequencies. To compensate for line impairments (attenuation) of a wireline cable (e.g., a seven conductor cable) and signal coupling/de-coupling devices, some embodiments may measure the data transmission capability of a subchannel and assign a data transmission rate for that subchannel to insure the subchannel is used at a reliable data transmission rate.

As an example, the transceiver 401 may be used with the ADSL frequency spectrum that comprises 64 discrete frequency subchannels of width 4.3125 kHz that are distributed between 2.15625 kHz and 278.15625 kHz. In at least some embodiments, data may be dynamically re-allocated during the transmission process to compensate for unpredictable noise and other factors that may result in some data being corrupted. This “dynamic bandwidth allocation” process may be carried out by routinely measuring the SNR (signal-to-noise ratio) across the spectrum of subchannels and adjusting the allocation of bits according to those measurements.

By categorizing data and separating data into a priority data stream 413 and a non-priority data stream 414, several processes may be employed by the digital signal processor 402 to help ensure priority data reliably reaches the surface. For example, the digital signal processor 402 may amplify signals on selected subchannels, assign less bits to selected subchannels, or move priority data using the “dynamic bandwidth allocation” described above. The operation of these processes may be controlled by the gain table 426, bit table 427, and tone table 428 mentioned above.

The gain table 426 may be used to amplify signals in select areas of the frequency spectrum. In at least some embodiments, the gain table 426 may amplify over frequency subchannels allocated for priority data. The bit table 427 designates how many data bits are assigned to each subchannel. Therefore, some embodiments may use bit table 427 to place less data bits in subchannels that carry priority data. The tone table 428 designates which data bits are assigned to each subchannel. Accordingly, the tone table 428 may be used to assign priority data bits to selected subchannels. These tables may be calculated and re-calculated to allow initial allocation of data to subchannels before transmission begins and dynamic transfer of data to and from subchannels during transmission, respectively.

The priority data control 424 may be used to designate the categories of data that are to be considered priority data. Therefore, in some embodiments, the priority data control 424 may program the interface logic 404, whereby incoming data is separated into a priority data stream 413 and non-priority data stream 414. Additionally, the priority data control 424 may operate in conjunction with the gain table 426, bit table 427, and tone table 428 described above, such that priority data bits are allocated to subchannels with lowest error rate. The priority data control 424 also may operate to control “safety margins” such that select subchannels carry less bits than their calculated capacity. In some embodiments, the priority data control 424 is customizable, and may be modified by downloading new information or updates to memory 420.

In some embodiments, the separation of data 412 into a priority data stream 413 and a non-priority data stream 414 allows the digital signal processor 402 to allocate priority data to select frequency subchannels as described above. The initial allocation of priority and non-priority data to frequency subchannels may occur simultaneously or consecutively. During uplink transmission, the allocation of data bits to subchannels may dynamically be adjusted as described above.

The signal from the digital signal processor 402 passes through a DAC and driver 407 which convert the signal into a corresponding analog signal. That signal may then be transmitted to the surface through the hybrid communication channel 408 and subsequent channel 416, where the downhole data may be reconstructed and further processed.

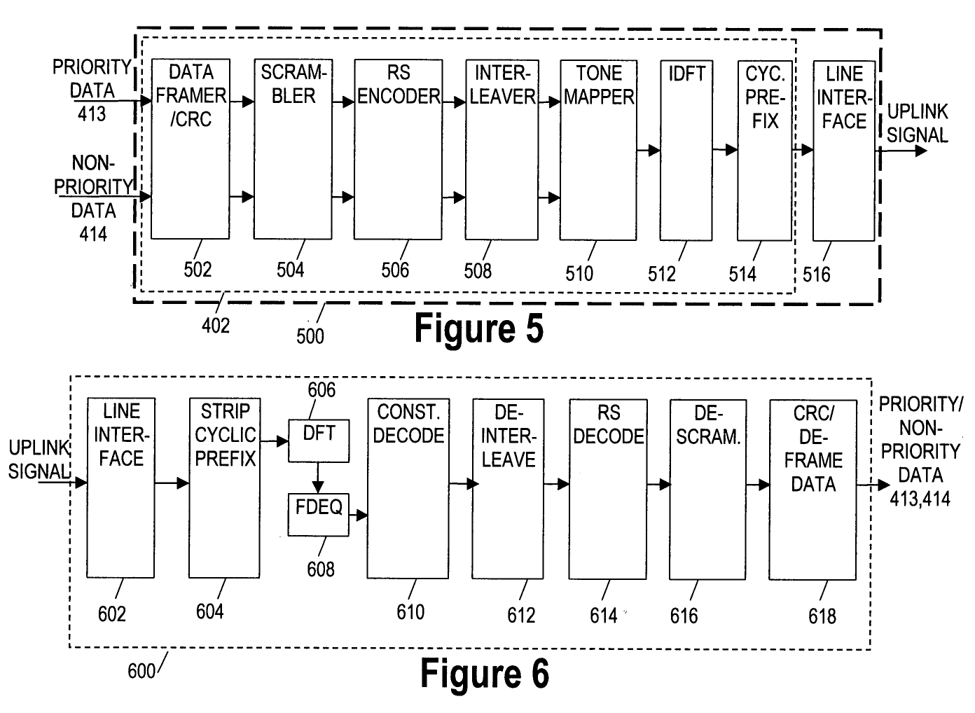

FIG. 5 illustrates a DMT transmitter 500 according to an embodiment of the present invention. As shown in FIG. 5, the DMT transmitter 500 may comprise a data framer 502, a scrambler 504, an encoder 506, an interleaver 508, a tone mapper 510, an inverse discrete Fourier transform (IDFT) block 512, a cyclic prefix generator 514, and a line interface 516. The data framer 502, scrambler 504, encoder 506, interleaver 508, tone mapper 510, IDFT block 512, and cyclic prefix generator 514 may be implemented within a digital signal processor 402. The line interface 407 may comprise a DAC, filters, and drivers.

The data framer 502 groups bytes of data together to form data frames. In operation, priority data 413 may be grouped into frames and non-priority data 414 may be grouped into frames without mixing the two types of data. The data frames may then be grouped with a synchronization frame and a cyclic redundancy checksum (CRC) which is calculated from the contents of the data frames. The CRC provides one means for detecting errors in data received at the receiving end. The scrambler 504 may combine the output of the data framer 502 with a pseudo-random mask. This “randomizes” the data so as to flatten the frequency spectrum of the data signal. Again, the priority data may be maintained separate from non-priority data.

The scrambled data may be encoded by encoder 506 with an error correction code that adds redundancy to the data stream. The redundancy may be used to detect and correct errors caused by channel interference. A Reed-Solomon (RS) code is preferred, but other error correction codes also (or alternatively) may be used. Interleaver 508 may be a convolutional interleaver which reorders data stream symbols so as to “spread out” previously adjacent symbols. This tends to prevent an error burst from overcoming the localized error correction ability of the error correction code.

Tone mapper 510 takes bits from the data stream and assigns them to frequency bins or subchannels. As previously described the priority data bits may be assigned to a first set of bins having the lowest calculated error rate and the non-priority data bits may be assigned to a second set of bins. For each frequency bin, the bits are used to determine a discrete Fourier transform (DFT) coefficient that specifies a frequency amplitude. The number of bits assigned to each frequency bin may be variable (i.e. may be different for each bin) and dynamic (i.e. may change over time), and depends on the estimated error rate for each frequency. Microcontrollers (not shown) at each end may be used to determine the error rate detected by the receiver in each frequency band, and to adjust the tone mapper accordingly.

The coefficients provided by the tone mapper 510 are processed by IDFT block 512 to generate a time-domain signal carrying the desired information at each frequency. The cyclic prefix block may duplicate the end portion of the time-domain signal and prepend it to the beginning of the time domain signal. As discussed further below, this permits frequency domain equalization of the signal at the receiving end. The prefixed signal may then be converted into analog form, filtered, and amplified for transmission across the communications channel by line interface 516, which may comprise a DAC, filter, and amplifier circuit.

FIG. 6 is a block diagram of a DMT receiver 600. As shown in FIG. 6, the DMT receiver 600 may comprise a line interface 602, a cyclic prefix stripper 604, a DFT block 606, an FDEQ or frequency domain equalizer 608, a constellation decoder 610, a de-interleaver 612, an error correction decoder 614, a descrambler 616, and a de-framer 618.

Line interface 602 may comprise filters, ADCs, and time equalization circuitry to filter the received signal, convert it to digital form, and perform any desired time domain equalization. The time domain equalization may at least partially compensate for distortion introduced by the channel, but it is likely that at least some intersymbol interference will remain. Stripper block 604 removes the cyclic prefixes that were added by the prefix block 514, but importantly, trailing intersymbol interference from the cyclic prefix remains in the signal. DFT block 606 performs a DFT on the signal to obtain the frequency coefficients. If desired, frequency domain equalization may be performed by block 608 to compensate for any remaining intersymbol interference. It is noted that frequency domain equalization on DFT coefficients may be a cyclic convolution operation which would lead to incorrect equalization results had the cyclic prefix not been transmitted across the channel.

The constellation decoder 610 may extract the data bits from the frequency coefficients using an inverse mapping of the tone mapper 510. De-interleaver 612 then returns the data stream to its original order. Decoder 614 decodes the data stream correcting such errors as are within its correcting ability, and descrambler 616 combines the data with the pseudo-random mask to return the data to its unscrambled form. De-framer 618 then identifies and removes synchronization information, and determines if the CRC indicates the presence of any errors. If error free, the data is forwarded to the output. Otherwise, a microcontroller as described previously, may be notified of errors in the data.

Together, FIGS. 5 and 6 show how tool data may be prioritized and conveyed across a communications channel. Downlink communications can be similarly conveyed. The components may be implemented as discrete hardware, or preferably may be implemented as software of a digital processor within the modem.

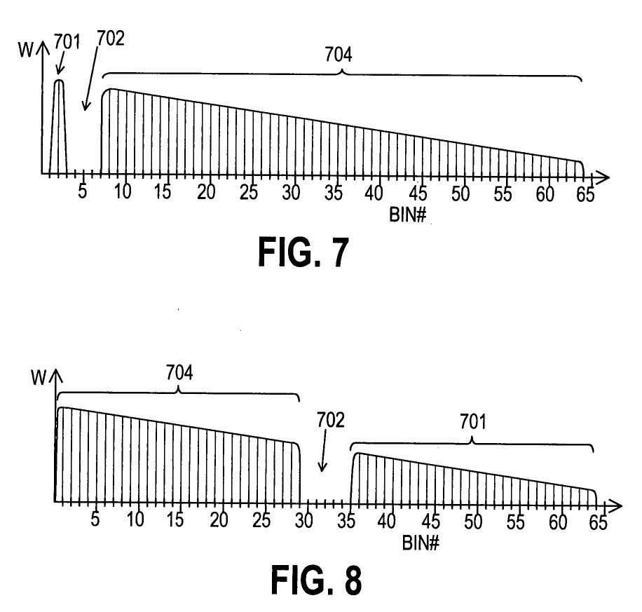

FIG. 7 shows a block diagram illustrating a standard DMT-ADSL frequency subchannel assignment. As shown in FIG. 7, subchannels #2-#3 (701) may be dedicated for downlink communications. Subchannels #4-#7 (702) may be used to provide a guard band between uplink and downlink communications. Channels #8-#63 (704) may be dedicated to uplink communications and one pilot channel.

In some embodiments, the uplink and downlink information transfer rate requirements may not be static as is assumed in most communication systems designs. During initialization and configuration of downhole instruments, it may be desirable to provide a downlink information transfer capacity that is substantially larger than the uplink information transfer capacity. The downlink may be used to transfer software, commands, and parameters, and the role of the uplink may be limited to acknowledging receipt of information packets. During normal operation, the downlink may be limited to acknowledgements or configuration change commands, while the uplink may carry measurement data and status information.

In at least some embodiments of the invention, the assignment of subchannels to uplink and downlink may be arranged to allow the downlink to transmit using the higher frequency subchannels and the uplink to use the lower frequency subchannels. In general, the lower frequency subchannels have lower error rates and are therefore desirable for sending priority data uplink as described above.

FIG. 8 shows a block diagram illustrating a DMT-ADSL frequency subchannel assignment according to an embodiment of the invention. As shown in FIG. 8, subchannels #1-#29 (704) may be dedicated for uplink communications and one pilot channel. Subchannels #30-#35 (702) may be used to provide a guard band between uplink and downlink communications. Channels #36-#63 (701) may be dedicated to downlink communications. Such an embodiment is desirable to provide priority uplink data with a set of frequency subchannels with the lower error rate. The embodiment of FIG. 8 also provides downlink communications with a larger number of frequency subchannels to use, thereby expanding the frequency spectrum used for downlink from two subchannels (as shown in FIG. 7) to twenty-eight subchannels.

The above discussion is meant to be illustrative of the principles and various embodiments of the present invention. Numerous other variations and modifications will become apparent to those skilled in the art once the above disclosure is fully appreciated. It is intended that the following claims be interpreted to embrace all such variations and modifications.

1. A downhole telemetry system comprising:
a surface transceiver;
a cable; and
a downhole transceiver coupled to the surface transceiver via the cable, wherein the downhole transceiver transmits a first category of data over a first set of frequency subchannels and a second category of data over a second set of frequency subchannels using discrete multi-tone modulation.

2. The system of claim 1 wherein the first category of data comprises data from a pre-determined tool.

3. The system of claim 1 wherein the first category of data comprises data from a pre-determined group of sensors within a tool.

4. The system of claim 1 wherein the first category of data comprises data samples from a data stream, the data samples are selected using a pre-determined sampling frequency.

5. The system of claim 1 wherein frequency subchannels of said first set have lower error rates than frequency channels of said second set.

6. The system of claim 1 wherein said first and second sets of frequency subchannels are at lower frequencies than a third set of frequency subchannels allocated for downlink communications.

7. A method for a downhole transmitter to communicate to a surface receiver, comprising:
transmitting over a first group of frequency subchannels data that has been categorized into a first set of data; and
transmitting over a second group of frequency subchannels data that has been categorized into a second set of data.

8. The method of claim 7 wherein the first set of data comprises data from a pre-determined tool.

9. The method of claim 7 wherein the first set of data comprises data from a pre-determined group of sensors within a tool.

10. The method of claim 7 wherein the first set of data comprises data samples from a data stream, the data samples are selected using a pre-determined sampling frequency.

11. The method of claim 7 wherein frequency subchannels of said first group have lower error rates than frequency subchannels of said second group.

12. A downhole transmitter, comprising:
a logic interface, the logic interface receives data from one or more tools and separates the data into a first set and a second set;
a digital signal processor coupled to the logic interface, the digital signal processor assigns the first set to a first group of frequency subchannels and the second set to a second group of frequency subchannels using discrete multi-tone modulation and outputs a corresponding signal; and
a line interface coupled to the digital signal processor, the line interface converts said corresponding signal from the digital signal processor to an analog signal and transmits said analog signal to a surface receiver.

13. The transmitter of claim 12 further comprising memory coupled to the digital signal processor and interface logic, said memory provides information to the digital signal processor such that the digital signal processor assigns the first set to a first group of frequency subchannels and the second set to a second group of frequency subchannels using discrete multi-tone modulation.

14. The transmitter of claim 13 wherein part of said second set is assigned to said first group of frequency subchannels.

15. The transmitter of claim 13 wherein the memory further provides information to the interface logic such that the interface logic separates the data into a first set and a second set.

16. The transmitter of claim 15 wherein said memory comprises a priority data control that said provides information to the interface logic such that the interface logic separates the data into a first set and a second set.

17. The transmitter of claim 16 wherein said memory further comprises:
a gain table, said gain table instructs the digital signal processor to amplify data carried on one or more subchannels;
a bit table, said bit table determines the number of bits assigned to a subchannel; and
a tone table, said tone table instructs the digital signal processor to assign the first set to a first group of frequency subchannels and the second set to a second group of frequency subchannels.

18. The transmitter of claim 17 wherein said gain table, bit table, and tone table are routinely calculated to permit dynamic allocation of data bits to a frequency subchannel.

19. The transmitter of claim 16 wherein the priority data control stores a data category, the data category is used by the interface logic such that the interface logic said separates the data into a first set and a second set according to the data category.

20. The transmitter of claim 19 wherein said data category comprises data from a pre-determined tool.

21. The transmitter of claim 20 wherein said data category further comprises data samples from a data stream of the pre-determined tool, the data samples are selected using a pre-determined frequency.

22. The transmitter of claim 19 wherein said data category comprises data a pre-determined group of sensors within a tool.

23. The transmitter of claim 22 wherein said pre-determined group of sensors comprises one or more rings of receivers of an acoustic tool.
